(19) United States
(12) Patent Application Publication
(10) Pub. No.: US 2004/0075913 A1
(43) Pub. Date: Apr. 22, 2004

(54) Imaging optical system and image reading apparatus

(75) Inventors: Kazuyuki Kondo, Saitama (JP); Nobuyuki Tochigi, Tochigi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/681,917

(22) Filed: Oct. 10, 2003

(30) Foreign Application Priority Data
Oct. 17, 2002 (JP) 2002-303168

(51) Int. Cl. G02B 17/00

(52) U.S. Cl. 359/726

(57) ABSTRACT

To provide an imaging optical system composed of off-axial reflective surfaces, which has a small size, which is less occurrence of asymmetrical aberration, and which has a high optical performance, and to provide an image reading apparatus using the imaging optical system. The imaging optical system according to the present invention, in which image information on a surface of an object is imaged onto a line sensor, includes an imaging optical element including a plurality of off-axial reflective surfaces, in which the imaging optical element includes at least one of the plurality of off-axial reflective surfaces, whose length in a pixel arrangement direction of the line sensor is longer than a length thereof in a direction perpendicular to the pixel arrangement direction of the line sensor.

### BACKGROUND OF THE INVENTION

1. Field of the Invention

The present invention relates to an imaging optical system and an image reading apparatus using the same. More particularly, the present invention relates to an imaging optical system and an image reading apparatus, which are suitable to read a monochrome image and a color image using an image scanner including an imaging optical element or using a line sensor of a digital copying machine, a facsimile, or the like, in which various aberrations in the imaging optical element are corrected in a balanced manner, and the imaging optical system has a high resolution, is a small type, and includes a plurality of off-axial reflective surfaces.

2. Related Background Art

Up to now, a flat bed type image scanner has been proposed as an image reading apparatus (image scanner) that reads image information on an original surface, for example, in Japanese Patent Application Laid-open No. 3-113961.

According to the flat bed type image sensor, an imaging lens and a line sensor are fixed and only a reflective mirror is moved, so that slit exposure scanning is conducted on the original surface to read the image information.

In recent years, in order to simplify a structure of an apparatus, a carriage-integrated scanning system in which mirrors, an imaging lens, a line sensor, and the like are integrally provided to scan the original surface is employed in many cases.

FIG. 6 is a main part schematic view showing a conventional image reading apparatus of the carriage-integrated scanning system. In FIG. 6, a light flux emitted from an illumination light source 1 directly illuminates an original 8 placed on an original table glass 2. A reflection light flux from the original 8 is reflected on a first reflection mirror 3a, a second reflection mirror 3b, and a third reflection mirror 3c in order, so that the optical path of the reflection light flux is bent in an inner portion of a carriage 6. The reflection light flux is imaged onto the surface of a line sensor 5 by an imaging lens (imaging optical system) 4. The carriage 6 is moved by a sub-scanning motor 7 in a direction indicated by an arrow A (sub-scanning direction) shown in FIG. 6 to read the image information of the original 8. The line sensor 5 shown in FIG. 6 has a structure in which a plurality of light receiving elements are arranged in one dimensional direction (main scanning direction) perpendicular to a paper surface of FIG. 6.

FIG. 7 is an explanatory view showing a fundamental structure of an image reading optical system shown in FIG. 6. In FIG. 7, an arrow indicates the main scanning direction.

In FIG. 7, the image reading optical system includes the imaging optical system 4 and the line sensor 5 composed of line sensors 5R, 5G, and 5B that respectively read R (red), G (green), and B (blue). Reference symbols 8R, 8G, and 8B denote reading areas on the original surface, which correspond to the line sensors 5R, 5G, and 5B. In the image reading apparatus shown in FIG. 6, the carriage 6 scans the original surface that remains stationary. The carriage scanning is equivalent to the state that the line sensor 5 and the imaging lens 4 remain stationary and the surface of the original 8 is moved, as shown in FIG. 7. When the original surface is scanned, the identical region can be read for different colors at certain intervals. In the case where the imaging lens 4 is composed of a general refraction system in the above-mentioned structure, because an axial chromatic aberration or a magnification chromatic aberration are produced, a defocus or a position displacement is caused on line images formed on the line sensors 5B and 5R, unlike the reference line sensor 5G. Therefore, in the case where the respective color images are superimposed for reproduction, the reproduced image shows color bleeding and color shift. That is, in the case where performances of a high aperture and a high resolution are required, the optical system cannot meet such requirements.

On the other hand, it has become apparent recently that an optical system in which an aberration is sufficiently corrected can be constructed even in a non-coaxial optical system, by introducing a concept of a reference axis and setting a composing surface to an asymmetrical and aspheric surface. The design method is described in, for example, Japanese Patent Application Laid-open No. 95650 and the design example is described in, for example, Japanese Patent Application Laid-open Nos. 8-292371 and 8-292372.

Such a non-coaxial optical system is called an off-axial optical system. In the case where a reference axis along a beam that transmits through an image center and a pupil center is assumed, the off-axial optical system is defined as an optical system including a curved surface (off-axial surface) in which a plane normal at an intersection point with the reference axis of the composing surface is not present on the reference axis. In this time, the reference axis becomes a bending shape. In the off-axial optical system, the composing surface generally becomes non-coaxial and there is no case where shading is caused on a reflective surface. Accordingly, it is easy to construct an optical system using the reflective surface. In addition, the off-axial optical system has characteristics that an optical path is relatively free to lead and an integrated optical system is easily formed by a method of integrally forming the composing surface.

However, Japanese Patent Application Laid-Open Nos. 09-005650, 08-0292371, and 08-0292372, which are described above, do not disclose an image reading apparatus using a line sensor, to which an off-axial optical system is applied.

### SUMMARY OF THE INVENTION

The present invention has been made in view of the above-mentioned problems. An object of the present invention is to provide an image reading apparatus that is small in size and has a high performance even in the case where an imaging optical system is composed of off-axial reflective surfaces.

According to a first aspect of the present invention, there is provided an imaging optical system in which image information on a surface of an object is imaged onto a line sensor, including:

an imaging optical element including a plurality of off-axial reflective surfaces,

the imaging optical element including at least one of the plurality of off-axial reflective surfaces, whose length in a pixel arrangement direction of the line sensor is longer than a length thereof in a direction perpendicular to the pixel arrangement direction of the line sensor.

According to the imaging optical system described above, it is preferable that the imaging optical element includes at least two of the plurality of off-axial reflective surfaces, whose length in the pixel arrangement direction of the line sensor is longer than the length thereof in the direction perpendicular to the pixel arrangement direction of the line sensor.

According to the imaging optical system described above, it is preferable that the at least two of the plurality of off-axial reflective surfaces, whose length in the pixel arrangement direction of the line sensor is longer than the length thereof in the direction perpendicular to the pixel arrangement direction of the line sensor, are the off-axial reflective surface located nearest to the object on an optical path of the imaging optical element and the off-axial reflective surface located nearest to the line sensor on the optical path of the imaging optical element.

According to the imaging optical system described above, it is preferable that the imaging optical element includes at least one of the plurality of off-axial reflective surfaces, which is a non-circular diaphragm, whose diameter in the pixel arrangement direction of the line sensor is longer than a diameter thereof in the direction perpendicular to the pixel arrangement direction of the line sensor.

According to the imaging optical system described above, it is preferable that, in a case where Fno of the imaging optical element in the sub scanning direction is given as Fs and Fno thereof in the main scanning direction is given as Fm, a condition of Fm≦Fs is satisfied.

Further, according to a second aspect of the present invention, there is provided an image reading apparatus including:

an imaging optical system according to the first aspect of the invention;

an original table on which an original is put as the object; and

the line sensor.

### BRIEF DESCRIPTION OF THE DRAWINGS

In the accompanying drawings:

FIG. 1 is a main part sectional view of a first embodiment of an imaging optical system for image reading according to the present invention;

FIG. 2 is an aberration graph of the first embodiment of the imaging optical system for image reading according to the present invention;

FIG. 3 is a main part schematic view of a first embodiment of an image reading apparatus according to the present invention;

FIG. 4 is a main part perspective view of the first embodiment of the imaging optical system for image reading according to the present invention;

FIG. 5 is a main part perspective view of a second embodiment of an imaging optical system for image reading according to the present invention;

FIG. 6 is a main part schematic view of an image reading apparatus of a conventional example;

FIG. 7 is an explanatory view showing a fundamental structure of an image reading optical system according to the conventional example; and

FIG. 8 is an explanatory view showing a definition of an off-axial optical system according to the present invention.

### DETAILED DESCRIPTION OF THE PREFERRED EMBODIMENTS

(First Embodiment)

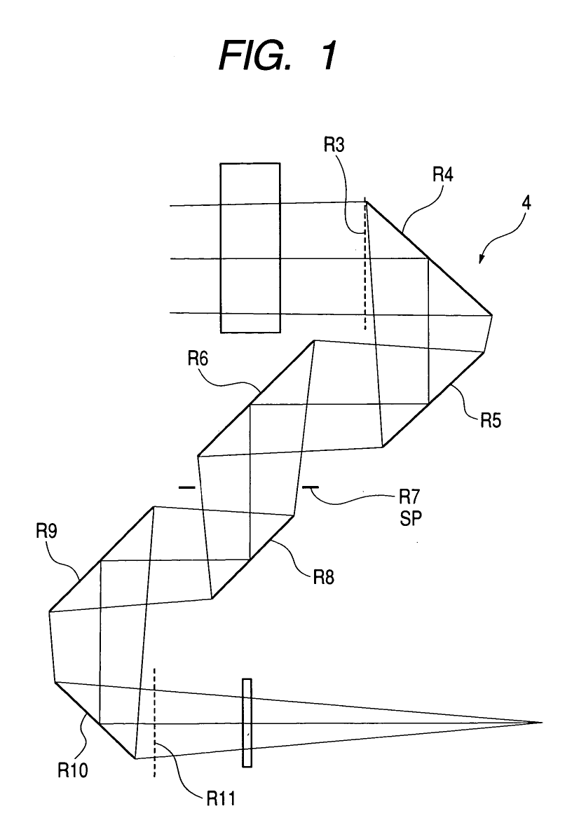

FIG. 1 is a main part sectional view of a first embodiment of an imaging optical element of the present invention.

In an imaging optical element 4 of the first embodiment, a direction of an exit surface R11 into which a reference axis beam is incident is identical to a direction of an incident surface R3 into which the reference axis beam is incident. The imaging optical element 4 includes six off-axial reflective surfaces (R4, R5, R6, R8, R9, and R10) each having a curvature. A medium among the reflective surfaces is air and a hollow structure in which no chromatic aberration is essentially caused is used. A direction of the incident beam becomes substantially identical to a direction of the exit beam by even number of reflections.

Here, assume that an off-axial reflective surface that deflects the reference axis beam in a clockwise direction is defined as a plus deflective surface and an off-axial reflective surface that deflects the reference axis beam in a counterclockwise direction is defined as a minus deflective surface. In this case, as for the imaging optical element 4 of this embodiment, the surface R4 which is a plus deflective surface, the surface R5 which is a plus deflective surface, the surface R6 which is a minus deflective surface, the surface R8 which is a plus deflective surface, the surface R9 which is a minus deflective surface, and the surface R10 which is a minus deflective surface are arranged in the stated order from an original surface 8 side.

The surface R10 which is nearest to the exit side is disposed on the original side with respect to an incident reference axis, which is nearer than the surface R4 which is nearest to the incident side. With this arrangement, an optical path emitted from the imaging optical element 4 to an imaging position, i.e., a so-called back focus portion can be disposed below a portion in which incident light reaches the surface R4 in substantially parallel thereto. Accordingly, a spatial arrangement can be efficiently made.

Further, a structure in which an asymmetrical aberration is cancelled is essentially preferable. Therefore, as for the off-axial reflective surfaces disposed before and after a diaphragm SP (R7), the surface R6 becomes minus whereas the surface R8 becomes plus, the surface R5 becomes plus whereas the surface R9 becomes minus, and the surface R4 becomes plus whereas the surface R10 becomes minus. The off-axial reflective surfaces become the identical if they are rotated 180 degrees about the diaphragm.

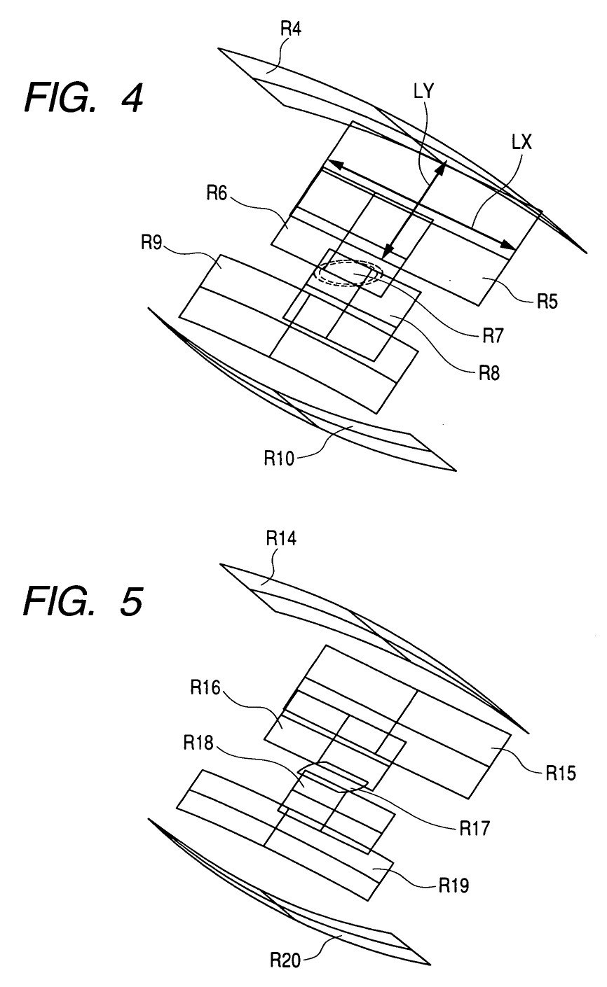

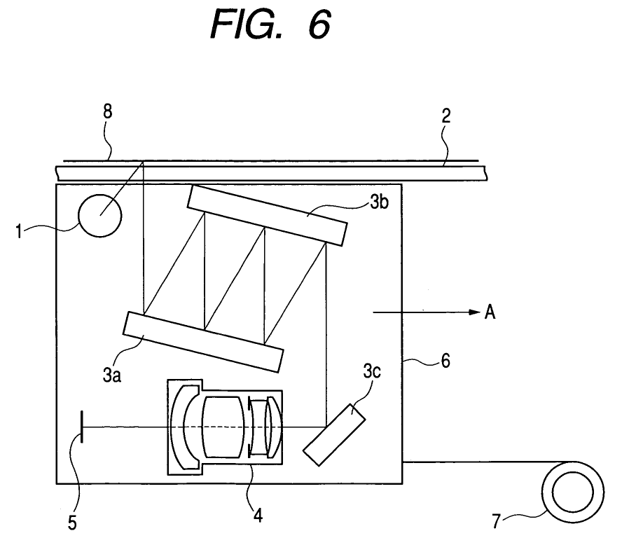

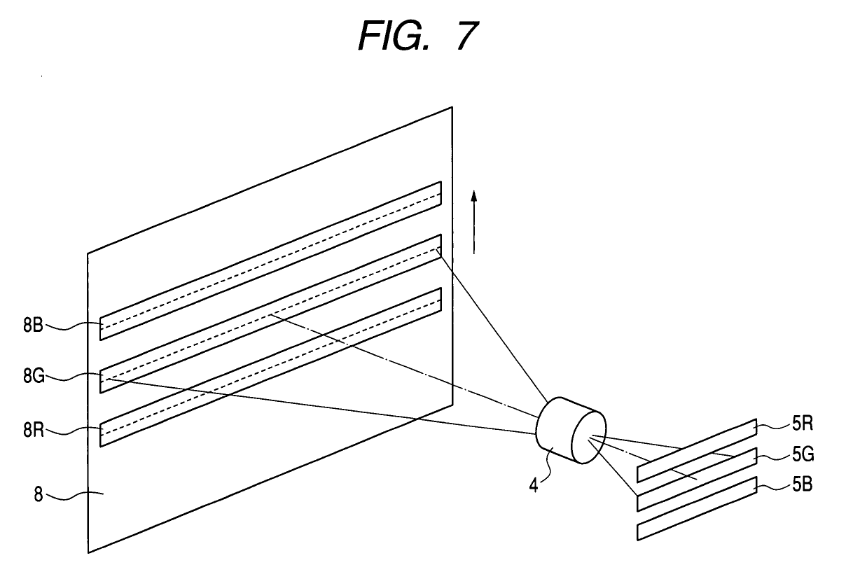

FIG. 4 is a perspective view of the imaging optical element 4 of the first embodiment. A feature of the present invention will be described in detail with reference to FIG. 4. In FIG. 4, an arrow LX indicates a main scanning direction which is a pixel arrangement direction of a line sensor 5 and an arrow LY is a sub scanning direction which is a direction perpendicular to the pixel arrangement direction of the line sensor 5.

In the case of an image reading apparatus using the line sensor as in the first embodiment, an angle of view in the main scanning direction is wide and an angle of view in the sub scanning direction is narrow. That is, an effective light flux width on the off-axial reflective surface becomes wider in the main scanning direction than that in the sub scanning direction.

Therefore, in the present invention, a size of each of the off-axial reflective surfaces is set such that a length LX in the main scanning direction becomes longer than a length LY in the sub scanning direction. That is, in FIG. 4, it is set such that LX becomes longer than LY.

In the case where a reduction in size of the imaging optical element 4 is considered, it is preferable that 4/3×LY≦LX is satisfied.

Thus, even if an optical path within a sub scanning section is bent, a wide space becomes dispensable, interferences among the respective off-axial reflective surfaces are avoided, whereby the size of the imaging optical element 4 can be reduced.

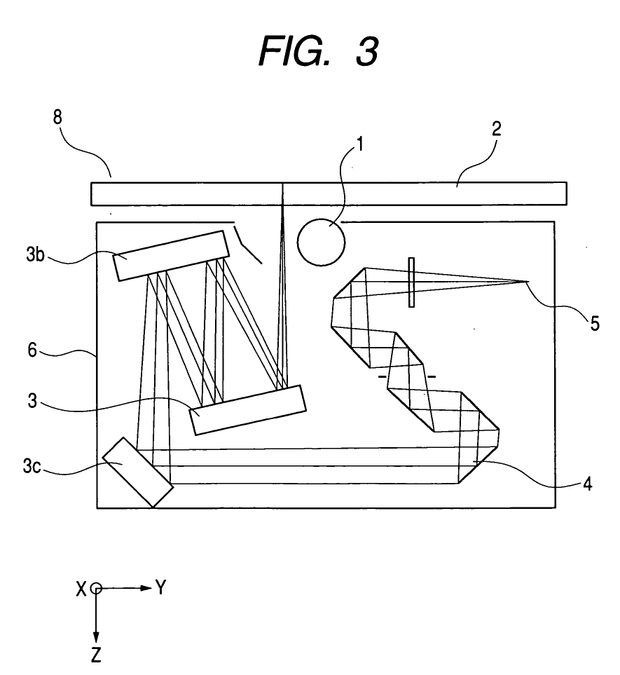

FIG. 3 shows an example in which the imaging optical element of the first embodiment as shown in FIGS. 1 and 4 is applied to an image reading apparatus of a carriage-integrated optical system. In FIG. 3, reference numeral 2 denotes an original table glass; 3a, 3b, and 3c, a first reflective mirror, a second reflective mirror, and a third reflective mirror, respectively; 4, an imaging optical element; and 5, a line sensor which is composed of CCDs or the like and extended in the main scanning direction (X-direction). Reflection light from an original 8 put on the original table glass 2 is imaged on the line sensor 5 by the imaging optical element 4, so that one line of the original can be read. In order to make the construction of the original reading apparatus compact, the optical path is folded by the first reflective mirror 3a, the second reflective mirror 3b, and the third reflective mirror 3c. It is unnecessary that the imaging lens be disposed in parallel to the reflective mirrors and below the reflective mirrors as in the conventional case. Accordingly, the image reading apparatus can be thinned in a depth (vertically in FIG. 3) direction (Z-direction). Further, because the CCDs or the like are disposed in the main scanning direction, a CCD board or the like does not protrude in the depth direction, so that the image reading apparatus can be thinned.

The carriage-integrated optical system relatively scans the original 8 with respect to a carriage 6 in a direction perpendicular to a line direction (X-direction) of the line sensor, that is, in the sub scanning direction (Y-direction) to thereby two-dimensionally read information on the surface of the original 8. Because the off-axial optical system can relatively freely lead an optical path, the surface of the original and the line sensor can be relatively freely located.

Therefore, in the case where there is used the imaging optical element in which the size of each of the off-axial reflective surfaces is set such that the length LX in the main scanning direction becomes longer than the length LY in the sub scanning direction, the size of the image reading apparatus 6 can be also reduced.

In this embodiment, the diaphragm R7 has a circular shape. In addition, it is set such that, assuming that Fno of the imaging optical element 4 in the sub scanning direction is Fs and Fno thereof in the main scanning direction is Fm, a relationship of Fm=Fs is satisfied.

In the first embodiment, each of all the off-axial reflective surfaces is set to a rectangular mirror in which the length LX in the main scanning direction becomes longer than the length LY in the sub scanning direction (FIG. 4) to thereby realize a reduction in size of the imaging optical element 4. As a modified example of the imaging optical element of the present invention, each of at least two off-axial reflective surfaces may be set to the rectangular mirror in which the length LX in the main scanning direction becomes longer than the length LY in the sub scanning direction. Here, the at least two off-axial reflective surfaces include the off-axial reflective surface which is nearest to the original on an optical path of the imaging optical element and the off-axial reflective surface which is nearest to the line sensor on the optical path of the imaging optical element.

In the case of the modified example of the present invention, as for each of the surface R4 and the surface R10 which are furthest from the diaphragm R7, a ratio of effective diameters between the main scanning direction and the sub scanning direction becomes maximum. Accordingly, in the case where each of the two surfaces is set to the rectangular mirror, an effect to a reduction in size becomes larger.

In the case of the modified example of the present invention, the surface R5, the surface R6, the surface R8, and the surface R9 other than the surface R4 and the surface R10 may be set to the circular mirror or the rectangular mirror.

In order to make clear the meanings of the structure and the numeral values in the embodiment of the imaging optical element including the plurality of off-axial reflective surfaces according to the present invention, the off-axial optical system and the reference axis serving as a frame thereof, which are used in this specification, are defined as follows.

(Definition of Reference Axis)

In general, an optical path from an object to an image surface, of a reference beam having a reference wavelength is defined as the reference axis in the optical system. This definition alone leaves an ambiguity with respect to how to select the reference beam. The reference beam, that is, the reference axis is generally set according to one of the following two rules.

1) In the case where a symmetrical axis is sectionally present in the optical system and an aberration can be symmetrically adjusted, a beam traveling on the symmetrical axis is assumed to be the reference beam.

2) In the case where the symmetrical axis is not generally present in the optical system or in the case where the aberration can be symmetrically adjusted even if the symmetrical axis is sectionally present, of beams exited from the center of the object surface (the center of a region to be photographed or to be observed), a beam that travels the surfaces of the optical system in a specified order and passes through the center of the diaphragm defined in the optical system is set as the reference beam.

The reference axis thus defined generally has a bending shape.

(Definition of Off-axial Optical System)

In points at which the reference axis defined above intersects curved surfaces, a curved surface on which a plane normal does not coincide with the reference axis is defined as an off-axial surface and an optical system including the off-axial surface is defined as an off-axial optical system. Note that, in the case where the reference axis is simply bent by a flat reflective surface, the plane normal does not coincide with the reference axis. However, because the flat reflective surface does not lose the symmetry of the aberration, it is excluded from the subject of the off-axial optical system.

According to the embodiment of the present invention, the reference axis serving as the reference of the optical system is set as described above. In determining an axis serving as the reference of the optical system, a suitable axis may be employed, considering an optical design, an adjustment of aberration, or a representation of shapes of respective surfaces composing the optical system.

However, generally, an optical path of a beam that passes through the center of an image surface or the center an observation surface and through any of the diaphragm, an entrance pupil, an exit pupil, the center of the first surface of the optical system, or the center of the final surface thereof is set to the reference axis serving as the reference of the optical system. The order of the respective surfaces is set to the order in which the beam on the reference axis is reflected.

Thus, the reference axis finally reaches the center of the image surface while a direction thereof is changed in accordance with the set order of the respective surfaces under the reflection law.

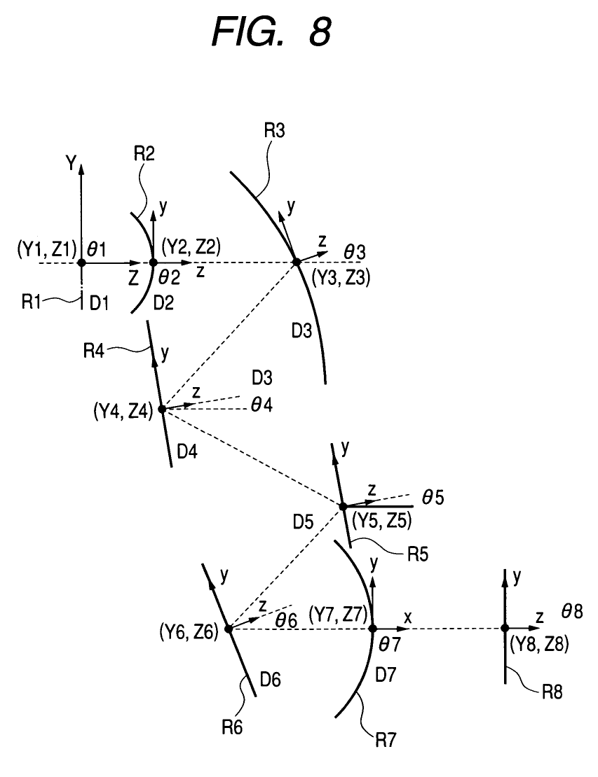

All tilt surfaces composing the optical system of the embodiment of the present invention are fundamentally tilted within the identical plane. Therefore, the respective axes of an absolute coordinate system are specified as follows (see FIG. 8).

Z-axis: a reference axis that passes through the origin and goes to a second surface

Y-axis: a straight line that passes through the origin and is rotated counterclockwise by 90° with respect to the Z-axis within the tilt surfaces (within the paper surface of FIG. 8)

X-axis: a straight line that passes through the origin and is perpendicular to both the Z-axis and the Y-axis (straight line perpendicular to the paper surface of FIG. 8)

Also, as for the representation of the surface shape of an i-th surface composing the optical system, the representation of the surface shape of the i-th surface using a local coordinate system in which the intersection between the reference axis and the i-th surface is assumed to be the origin is easier to recognize the shape, rather than the representation of the surface shape using the absolute coordinate system. Accordingly, in the embodiment of the present invention in which composing data is displayed, the surface shape of the i-th surface is represented using the local coordinate system.

Also, a tilt angle within the Y-Z plane of the i-th surface is represented by an angle θi (° of units) in which a counter clockwise direction with respect to the Z-axis of the absolute coordinate system is assumed to be positive. Therefore, according to the embodiment of the present invention, the origin of the local coordinate system on each of the surfaces is located within the Y-Z plane in FIG. 8.

In addition, no decentering of the surface on the X-Z plane and the X-Y plane is caused. Further, the y-axis and the Z-axis in the local coordinate (x, y, z) of the i-th surface are tilted by the angle θi within the Y-Z plane with respect to the absolute coordinate (x, y, z). More Specifically, the Z-axis, the Y-axis, and the X-axis are set as follows.

Z-axis: a straight line that passes through the origin of the local coordinate system and is rotated counterclockwise by the angle θi within the Y-Z plane with respect to the Z-axis direction of the absolute coordinate system

Y-axis: a straight line that passes through the origin of the local coordinate system and is rotated counterclockwise by 90° within the Y-Z plane with respect to the Z-axis direction

X-axis: a straight line that passes through the origin of the local coordinate system and is perpendicular to the Y-Z plane.

Also, the imaging optical element in the embodiment of the present invention has an aspheric surface with rotational asymmetry and a shape thereof is expressed by the following equation.

z=C₀₂y²+C₂₀x²+C₀₃y³+C₂₁x²y+C₀₄y⁴+C₂₂x²y²+C₄₀x⁴+C₀₅y⁵+C₂₃x²y³+C₄₁ x⁴y+C₀₆y⁶+C₂₄x²y⁴+C₄₂x⁴y²+C₆₀x⁶

Note that a spherical surface is a shape expressed by the following equation.

z=((x²+y²)/rᵢ)/(1+(1−(x²+y²)/rᵢ)^{1/2}

The above-mentioned curved surface equation includes only even order terms with respect to x. Therefore, a curved surface specified by the above-mentioned curved surface equation is a plane symmetrical shape in which the y-z plane is a symmetrical plane. Further, in the case where the following condition is satisfied, the curved surface expresses a symmetrical shape with respect to the x-z plane. In the case where

C₀₃=C₂₁=0

C₀₂=C₂₀

C₀₄=C₄₀=C₂₂/2

C₀₅=C₂₃=C₄₁=0

C₆₀=C₀₆=C₂₄/3=C₄₂/3

are satisfied, the curved surface expresses a rotationally symmetrical shape. In the case where the above-mentioned conditions are not satisfied, the curved surface is a non-rotationally symmetrical shape.

In addition, because each embodiment of the optical system is not an coaxial optical system, it is difficult to directly calculate a focal distance based on the paraxial theory. Therefore, a conversion focal distance f_{eq} defined by the following equation is used.

f_{eq}=h₁/tan(aₖ′)

Note that, in the case where the number of reflective surfaces is odd in view of the definition, a sign of the focal distance expresses the reverse of a general signal.

Here,

h₁: an incident height of a beam which is incident parallel to the reference axis and infinitely close to the reference axis on the first surface, and

aₖ′: an angle formed with the reference axis when the beam is exited from the final surface.

Next, in a numeral embodiment, with respect to the reference axis extending from the first surface R1 to the imaging surface, which is indicated by a dashed line, a sign of a curvature radius Ri is assumed to be minus in the case where the center of curvature is located in the first surface R1 side and the sign thereof is assumed to be plus in the case where the center of curvature is located in the imaging surface side.

Also, reference symbol Di denotes a scalar indicating an interval between the origins of the local coordinate system between the i-th surface and the (i+1)-th surface and Ndi denotes a refraction index of a medium between the i-th surface and the (i+1)-th surface.

An effective size (Lx×Ly) is an effective size with respect to the x-axis direction and the y-axis direction of the local coordinate system on each of the surfaces.

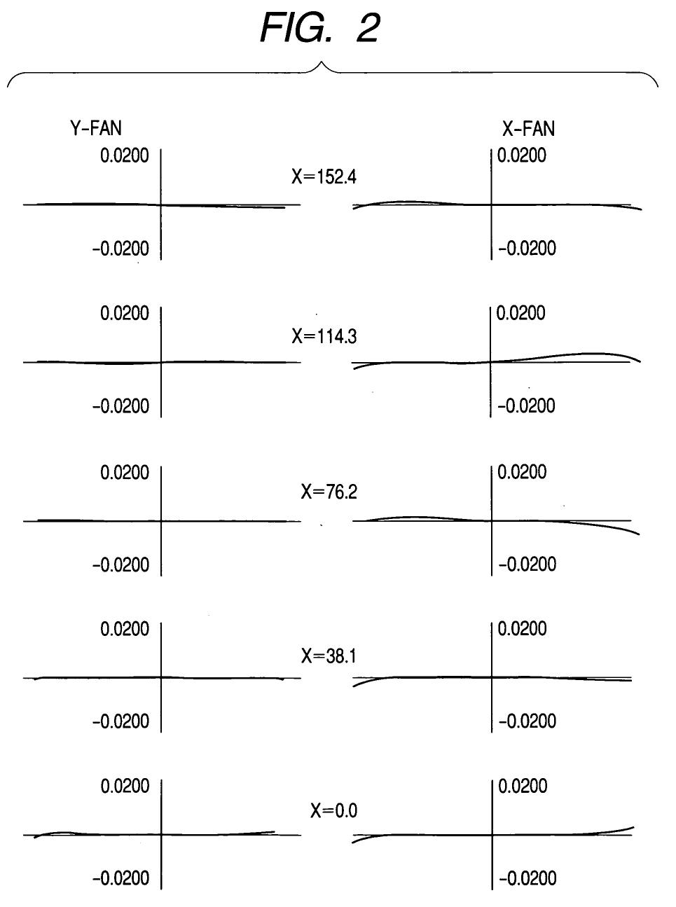

Numeral data in the first embodiment of the present invention as described above will be described below. FIG. 2 is an aberration graph of the numeral data.

Original Reading Width 305 mm, Imaging Magnification −0.22028

| Original | Side NA | 0.0201, f_{eq} 49 | | | | Effective Size | |
|---|---|---|---|---|---|---|---|
| i | Y_{I} | Zᵢ | θᵢ | Dᵢ | N_{di} | (Lx × Ly) | |
| 1 | 0.0 | −199.0 | 0.0 | 4.0 | 1.5 | | Object Surface |
| | | | | | | | (Original Surface) |
| 2 | 0.0 | −195.0 | 0.0 | 195.0 | 1.0 | | Transmission Surface |
| 3 | 0.0 | 0.0 | 0.0 | 10.0 | 1.0 | | Transmission Surface |
| 4 | 0.0 | 10.0 | 45.0 | 10.0 | 1.0 | 55.9 × 19.8 | Reflective Surface |
| 5 | −10.0 | 10.0 | −45.0 | 12.0 | 1.0 | 30.7 × 12.7 | Reflective Surface |
| 6 | −10.0 | −2.0 | −45.0 | −6.0 | 1.0 | 19.2 × 11.3 | Reflective Surface |
| 7 | −16.0 | −2.0 | 0.0 | −5.0 | 1.0 | 7.7 | Transmission Surface |
| | | | | | | | (Diaphragm) |
| 8 | −21.0 | −2.0 | −45.0 | 10.0 | 1.0 | 15.1 × 8.8 | Reflective Surface |
| 9 | −21.0 | −12.0 | −45.0 | −11.5 | 1.0 | 36.2 × 11.5 | Reflective Surface |
| 10 | −32.5 | −12.0 | 45.0 | 10.0 | 1.0 | 49.1 × 10.5 | Reflective Surface |
| 11 | −32.5 | −2.0 | 0.0 | 0.7 | 1.5 | | Transmission Surface |
| 12 | −32.5 | −1.3 | 0.0 | 19.70 | 1.0 | | Transmission Surface |
| 13 | −32.5 | 18.4 | | | 1.0 | | Imaging Surface |
| | | | | | | | (Sensor Surface) |

Aspheric Surface Shape

| | | |
|---|---|---|
| Surface R4 | | |
| C₀₂ = −4.6370e−3 | C₀₃ = 4.7956e−5 | C₀₄ = −3.8778e−7 |
| C₀₅ = −2.6373e−8 | C₀₆ = −4.1368e−10 | C₂₀ = −2.2522e−3 |
| C₂₁ = 4.6045e−5 | C₂₂ = −6.4075e−7 | C₂₃ = −3.6626e−9 |
| C₂₄ = 9.5021e−10 | C₄₀ = 8.0691e−8 | C₄₁ = −1.2313e−9 |
| C₄₂ = −1.0275e−10 | C₆₀ = −4.4066e−12 | |
| Surface R5 | | |
| C₀₂ = −7.9557e−3 | C₀₃ = −1.9354e−5 | C₀₄ = −1.7661e−7 |
| C₀₅ = −2.7155e−7 | C₀₆ = −1.7098e−8 | C₂₀ = −2.9139e−3 |
| C₂₁ = 2.2513e−4 | C₂₂ = 1.1500e−6 | C₂₃ = 1.9226e−7 |
| C₂₄ = 1.0393e−8 | C₄₀ = −3.1571e−6 | C₄₁ = 2.1718e−10 |
| C₄₂ = −3.2272e−9 | C₆₀ = −2.2044e−10 | |
| Surface R6 | | |
| C₀₂ = −7.3984e−3 | C₀₃ = −8.9040e−5 | C₀₄ = −3.3142e−6 |
| C₀₅ = −1.1728e−7 | C₀₆ = −1.2995e−8 | C₂₀ = −1.0503e−2 |
| C₂₁ = 4.4162e−5 | C₂₂ = −5.6571e−7 | C₂₃ = 2.8155e−7 |
| C₂₄ = 6.6068e−9 | C₄₀ = −1.7855e−6 | C₄₁ = −1.8879e−8 |
| C₄₂ = −3.4977e−10 | C₆₀ = −3.6874e−10 | |
| Surface R8 | | |
| C₀₂ = −1.2363e−2 | C₀₃ = −2.3209e−4 | C₀₄ = −2.2229e−5 |
| C₀₅ = −3.5502e−7 | C₀₆ = −1.5995e−7 | C₂₀ = −1.2225e−2 |
| C₂₁ = 6.9852e−5 | C₂₂ = −1.4608e−5 | C₂₃ = 1.2372e−6 |
| C₂₄ = 6.2157e−8 | C₄₀ = 2.0029e−6 | C₄₁ = 3.8246e−7 |
| C₄₂ = −2.3096e−8 | C₆₀ = −1.3092e−8 | |
| Surface R9 | | |
| C₀₂ = −7.9876e−3 | C₀₃ = 2.8932e−5 | C₀₄ = 2.1422e−6 |
| C₀₅ = 1.5135e−7 | C₀₆ = −2.6037e−9 | C₂₀ = −6.9135e−3 |
| C₂₁ = 1.1755e−4 | C₂₂ = −1.7268e−6 | C₂₃ = 2.3870e−7 |
| C₂₄ = −1.0577e−9 | C₄₀ = 8.1403e−7 | C₄₀ = 2.7851e−8 |
| C₄₂ = −1.6593e−9 | C₆₀ = −1.0464e−11 | |
| Surface R10 | | |
| C₀₂ = 8.2240e−4 | C₀₃ = 1.3187e−4 | C₀₄ = −6.7315e−6 |
| C₀₅ = 2.9663e−7 | C₀₆ = −4.2567e−9 | C₂₀ = 4.3524e−3 |
| C₂₁ = 4.4682e−5 | C₂₂ = 3.6473e−6 | C₂₃ = 5.7219e−8 |
| C₂₄ = 1.4368e−9 | C₄₀ = −7.9626e−7 | C₄₁ = −1.5383e−8 |
| C₄₂ = 1.2792e−19 | C₆₀ = 2.5752e−19 | |

FIG. 5 shows a second embodiment of the present invention. In the case of the first embodiment, a general circular diaphragm is used for the surface R7 of the diaphragm. In this embodiment, a rectangular diaphragm in which a length in the main scanning direction is longer than that in the sub scanning direction is used for a surface R17 of a diaphragm. By using the rectangular diaphragm, a light flux width in the sub scanning direction can be further narrowed and a further reduction in size in the sub scanning direction can be achieved. In addition, according to this embodiment, in the case where Fno of the imaging optical element in the sub scanning direction is given as Fs and Fno thereof in the main scanning direction is given as Fm, it is set such that a relationship of Fm≦Fs is satisfied. Thus, by making Fno in the sub scanning direction larger than Fno in the main scanning direction, a depth in the sub scanning direction can be increased together with a reduction in size. Even in the case where a manufacturing error such as profile irregularity of the off-axial reflective surface or decentering thereof is caused, it is possible to obtain a high-performance imaging optical element in which performance degradation in the sub scanning direction is hardly caused.

Considering the reduction in size of the imaging optical element, it is preferable that (4/3)×Fm≦Fs is satisfied.

According to the present invention, in the imaging optical system in which image information on the object surface is imaged onto the line sensor,

the imaging optical system includes an imaging optical element having a plurality of off-axial reflective surfaces, and

the imaging optical element has at least one of the off-axial reflective surfaces, whose length in a pixel arrangement direction of the line sensor is longer than that in a direction perpendicular to the pixel arrangement direction of the line sensor. Thus, a reduction in size of the imaging optical element is possible.

What is claimed is:

1. An imaging optical system in which image information on a surface of an object is imaged onto a line sensor, comprising:
an imaging optical element including a plurality of off-axial reflective surfaces,
the imaging optical element including at least one of the plurality of off-axial reflective surfaces, whose length in a pixel arrangement direction of the line sensor is longer than a length thereof in a direction perpendicular to the pixel arrangement direction of the line sensor.

2. An imaging optical system according to claim 1, wherein the imaging optical element includes at least two of the plurality of off-axial reflective surfaces, whose length in the pixel arrangement direction of the line sensor is longer than the length thereof in the direction perpendicular to the pixel arrangement direction of the line sensor.

3. An imaging optical system according to claim 2, wherein the at least two of the plurality of off-axial reflective surfaces, whose length in the pixel arrangement direction of the line sensor is longer than the length thereof in the direction perpendicular to the pixel arrangement direction of the line sensor, are the off-axial reflective surface located nearest to the object on an optical path of the imaging optical element and the off-axial reflective surface located nearest to the line sensor on the optical path of the imaging optical element.

4. An imaging optical system according to claim 1, wherein the imaging optical element includes at least one of the plurality of off-axial reflective surfaces, which is a non-circular diaphragm, whose diameter in the pixel arrangement direction of the line sensor is longer than a diameter thereof in the direction perpendicular to the pixel arrangement direction of the line sensor.

5. An imaging optical system according to claim 1, wherein, in a case where Fno of the imaging optical element in the sub scanning direction is given as Fs and Fno thereof in the main scanning direction is given as Fm, a condition of Fm≦Fs is satisfied.

6. An image reading apparatus comprising:
an imaging optical system according to any one of claims 1 to 5;
an original table on which an original is put as the object; and
the line sensor.
